(19) United States
(12) Patent Application Publication
(10) Pub. No.: US 2007/0041722 A1
(43) Pub. Date: Feb. 22, 2007

(54) Light diffuser

(76) Inventor: Gary M. Fong, Marina Del Rey, CA (US)

Correspondence Address: CHRISTIE, PARKER & HALE, LLP, PO BOX 7068, PASADENA, CA, 91109-7068, US

(21) Appl. No.: 11/209,273

(22) Filed: Aug. 22, 2005

(51) Int. Cl. G03B 15/03

(52) U.S. Cl. 396/176

(57) ABSTRACT

A photographic light diffusing system includes a camera having both a lens unit and a flash unit, and a light diffuser having a semi-transparent panel with an aperture mounted on the lens unit of a camera. The semi-transparent panel of the light diffuser obscures the flash unit when viewed from a subject in a field of view of the lens unit of a camera. The semi-transparent panel of the light diffuser may also include a textured surface on a side of the semi-transparent panel furthest from the flash unit, the textured surface being made up of a field of raised pyramids provided on the semi-transparent panel.

### FIELD OF THE INVENTION

The present invention relates to photographic light diffusers and more particularly to portable light diffusers for use with handheld cameras featuring on-camera flash units.

### BACKGROUND

In photography, it is important the lighting used to illuminate a subject to have a certain amount of uniformity. Each particular shot to be lighted dictates the type and intensity of light needed; in some situations direct light from a light source without any alteration may be required. In other situations direct lighting may be too strong or cast overly distinct shadows in which case a more diffuse light is desirable.

Diffuse lighting accessories are photography devices commonly used in a studio setting to provide soft lighting effects. Traditionally with these accessories, light can be either directly or indirectly passed through a semi-transparent material, or it may be reflected off a material which will cause it to scatter somewhat. Such diffuse lighting is commonly produced by light sources which are remote from the camera. Typically, such light diffusers are provided by stationary screens, umbrellas, soft boxes and the like. Such devices provide excellent lighting effects in fixed studio settings where there is no need to transport the lighting equipment including the diffusers from place to place. However, while this equipment provides good lighting effects in a fixed studio setting, it can be inconvenient if not impossible to use such stationary lighting accessories outside of the photography studio.

Handheld digital cameras are increasingly popular both with amateurs and with a growing contingent of professional photographers. These cameras combine portability and ease of use and allow for truly mobile, spontaneous photography. However, these point-and-shoot digital cameras are often provided with an extremely small on-camera flash unit which provides extremely harsh and direct light. With these cameras one does not have the benefit of controlling the lighting environment to the same degree as in a professional studio. These cameras usually feature a built in flash molded into the body of the camera itself, and these on-camera flashes can be hard to work with and often provide concentrated light when used. Furthermore, while larger digital cameras may feature separate flash heads similar to professional film cameras, the on-camera flash of the smaller versions of the new digital cameras are not suitable to mount a diffusing unit to. Therefore, there is not currently an acceptable method of providing good quality diffuse light from the on-camera flash of a handheld camera, due to the difficulty in mounting any device that would aid in the diffusion to the on-camera flash.

### SUMMARY OF THE INVENTION

In an exemplary embodiment, a photographic light diffusing system includes a camera having both a lens unit and a flash unit, and a light diffuser having a semi-transparent panel with an aperture mounted on the lens unit of a camera. The semi-transparent panel of the light diffuser obscures the flash unit when viewed from a subject in a field of view of the lens unit of a camera. In a further embodiment, the semi-transparent panel of the light diffuser includes a textured surface on a side of the semi-transparent panel furthest from the flash unit. In yet a further embodiment, the textured surface comprises a field of raised pyramids provided on the semi-transparent panel.

In an alternative embodiment, a photographic light diffusing system includes a set of at least two adaptor rings, namely a first adaptor ring adapted to be mounted on a lens of a camera and a second adaptor ring adapted to be mounted on the lens of the camera. A light diffuser is also provided comprising a semi-transparent panel having an aperture for receiving either of the first or the second adaptor rings to accommodate lens barrels of different diameters. The first adaptor ring has an interior diameter equal to a first diameter, and an exterior diameter equal to a third diameter. The second adaptor ring has an interior diameter equal to a second diameter different than the first diameter, and an exterior diameter equal to the third diameter, and the aperture has a diameter equal to the third diameter.

In another alternative embodiment, a photographic light diffuser includes a semi-transparent panel which has an aperture adapted to be mounted on a lens unit of a camera. The semi-transparent panel obscures a flash unit of the camera when viewed from a subject in a field of view of the lens unit of the camera.

### BRIEF DESCRIPTION OF THE DRAWINGS

FIG. 1 shows a front view of a photographic light diffuser mounted on a handheld camera according to one embodiment of the present invention;

FIG. 2 shows a side view of the photographic light diffuser of FIG. 1;

FIG. 3 shows a perspective view a photographic light diffuser according to another embodiment the present invention; and

FIG. 4 shows a perspective view of a section of a diffusing surface a photographic light diffuser according another embodiment of the present invention.

Before any embodiment of the invention is explained in detail, it is to be understood that the invention is not limited in its application to the details of construction and arrangements of components set forth in the following description, or illustrated in the drawings. The invention is capable of alternative embodiments and of being practiced or being carried out in various ways. Also, it is to be understood that the terminology used herein is for the purpose of illustrative description and should not be regarded as limiting.

### DETAILED DESCRIPTION

Photographs taken with digital point and shoot cameras using the on-camera flash can be extremely difficult to light properly because of the high contrast limitations imposed by such on-camera flashes. However, these point-and-shoot digital cameras typically feature an extremely small flash unit that provides very unflattering light quality when flash photos are taken. Therefore as discussed above, a need exists for a diffusing unit which may be easily mounted on a handheld digital camera and provide the high quality lighting available from diffusers used with separate flash heads on professional cameras. However, the solution of where and how to mount such a diffuser is not immediately apparent with cameras having flash units mounted flush with the body of the camera. This problem is further compounded by the tendency of any light diffuser which comes close to the front of the lens of the camera to flare, potentially spoiling the shot.

The use of semi-opaque flash diffusing media is well known in the art; for example many on-camera flashes such as those on disposable cameras are provided with a plastic panel directly in front of the flash tube and flush with the body of the camera to aid in the diffusion of the light from the flash. Without such an opaque medium, the point of origin of the illuminating rays of the flash is the filament of the flash tube itself, giving pictures taken with such an unshielded flash a far too harsh and direct lighting quality. With the provision of a flash diffusing medium in front of the flash tube however, the light from the flash tube refracts through the medium to cause a profile having a greater surface area of to emit light than would be possible with the tube alone. However, the size of the diffusing medium on such disposable and handheld cameras is ultimately limited by requirement that the medium be integrated with the body of the camera itself, limiting the total diffusing area available for lighting shots using the on-camera flash unit.

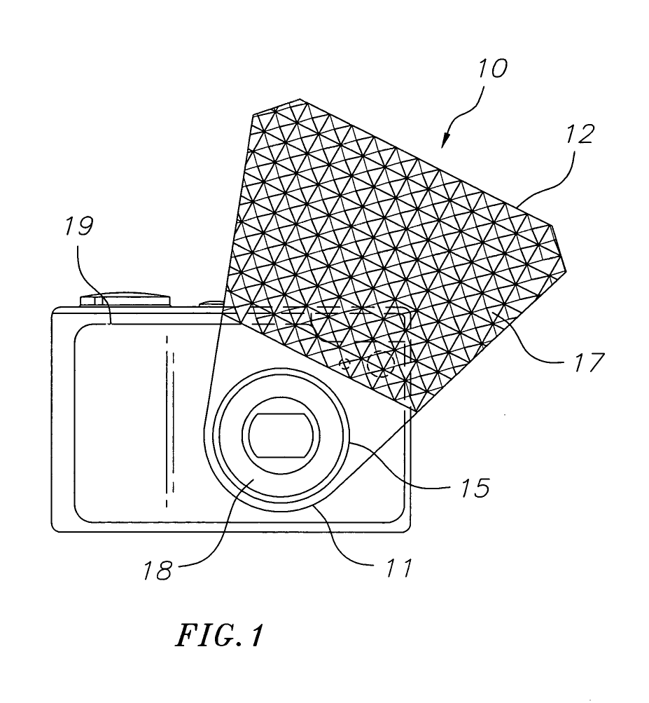

In contrast, the present photographic flash diffuser provides high quality lighting effects when used with built-in electronic on-camera flashes on digital or similar cameras without the need for separate stand-alone lighting equipment. FIG. 1 shows for example a front view of a photographic light diffuser 10 mounted on a handheld camera according to one embodiment of the present invention. As shown, an aperture is provided in the center, or slightly off-center of the mounting end 11 of the diffuser 10. This aperture allows the diffuser 10 to be mounted on the lens barrel 18 of the camera 19 using an adaptor ring 15 fitted inside the aperture. The adaptor ring 15 may be provided with a plurality of arms or bristles to allow it to fit a variety of different lens barrels from various model cameras, and in the embodiment shown fits over the lens barrel 18 of a handheld camera 19, which may be a portable digital camera having an on-camera flash unit. Because the diffuser may be friction fitted to the lens barrel of the camera, the adaptor must be able to be easily removed when shooting is finished as most lens barrels retract into the interior of the camera when not in use. Accordingly, the adaptor ring 15 may be provided by a flexible vinyl ring which snaps into place in the aperture in the mounting end 11 of the diffuser 10, and which may be easily removed from the lens barrel 18 of the camera 19 when shooting is finished.

A diffusing end 12 of the diffuser 10 is provided with a diffusing area 17 which obscures the flash unit of the camera 19 so that when the flash is used, the light emitted passes through the diffusing area 17 of the diffuser 10 which may be made of a vinyl or semi-opaque plastic, allowing light to be dispersed upon exposure to effectively cut down on glare and harsh lighting effects in photographs taken with the camera 19. Thus, good quality diffuse light from the flash unit is provided and the light source illuminating a subject is effectively enlarged. In order to accommodate the position of the flash unit on various model cameras, the present embodiment allows the diffuser to be rotated around the lens barrel of the camera to obscure flash units placed in different locations on various camera models.

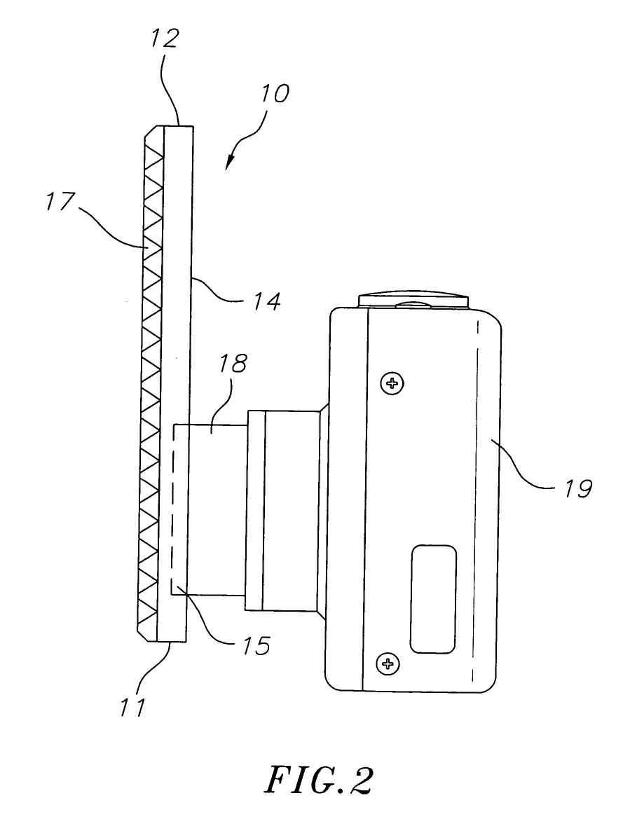

FIG. 2 shows a side view of the photographic light diffuser 10 of FIG. 1. Here, as in FIG. 1, the mounting end 11 of the diffuser 10 is shown attached directly to the front of a telescopic lens barrel 18 of what in this embodiment is a point and shoot camera 19. On the opposite or diffusing end 12 of the diffuser 10, a backing portion 14 is provided as a semitransparent structural layer to support the diffusing area 17 of the diffuser 10. The side view of the diffuser 10 of FIG. 2 also shows that with the model camera 19 shown, when the diffuser 10 is mounted on the end of the telescopic lens barrel 18 and the lens barrel 18 is fully extended, the distance from the diffuser 10 to a body of the camera 19 may be approximately one inch.

Part of the effectiveness of the diffuser 10 in providing soft, diffuse light relies on the effective flash area of the diffuser itself, i.e. the area of the diffuser 10 through which light rays will refract before exiting the diffuser to illuminate a subject. Thus, in one embodiment of the present invention, a large diffuser is selected knowing that light rays emitted from the flash unit which penetrate the diffusing medium tend to reflect within the medium and exit from the diffuser in a far more even manner than they entered. As discussed in further detail below, a textured surface may be provided on the surface of the diffuser to further increase the diffusive qualities of the diffuser 10. In the embodiment shown, this textured surface may take the form of a field of pyramids comprising the diffusing area 17.

Furthermore, in the embodiment of the present invention shown in FIG. 2, some of the diffuse lighting effect observed by a subject comes not from light rays refracted through the diffuser 10, but from rays reflected from the rear surface of the diffuser 10 closest to the flash unit on the camera 19. These rays, once reflected back from the diffuser 10, may bounce around the walls and ceilings of a room before illuminating a subject. Because of the scattering effect produced by the diffusing area and the randomness of the light reflected around the room, the diffuser 10 provides similar lighting effects regardless of its orientation in either a vertical or horizontal position or therebetween, provided that the diffuser is positioned with a sufficient area between the flash unit on the camera 19 and the subject.

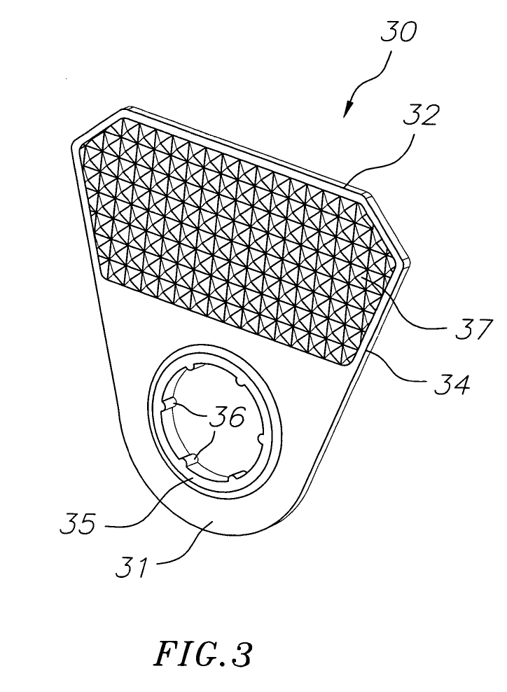

FIG. 3 shows a perspective view a photographic light diffuser 30 according to another embodiment the present invention. As with the previous embodiments, the diffuser 30 includes an aperture provided in the center, or slightly off-center of the mounting end 31 of the diffuser 30. An adaptor ring 35 may be fitted inside the aperture to allow the diffuser 30 to be mounted on the lens barrel of a camera. In this embodiment, the adaptor ring 35 includes protrusions 36 to allow the adaptor ring 35 to fit a variety of different lens barrels from various model cameras.

In one embodiment, rather than being made from a stiffer material and designed to fit a single model camera, the adaptor ring 35 may be a gasket-style adapter made from a flexible material to fit various cameras from different manufacturers. The use of a diffuser 30 with a “universal-mount” adaptor ring of this embodiment permits a single diffuser 30 to be used with various cameras having lens barrels of widely different shapes. As such, the adaptor ring 35 may be provided as one of a series of rings, any one of which may be snapped into place in the aperture in the mounting end 31 of the diffuser 30, each ring differing at least in its interior diameter, thus allowing the diffuser 30 to be adapted for a number of different lens barrels having a range of exterior diameters. These diameters may range in various embodiments from 22 mm to 44 mm.

The embodiment of FIG. 3 more clearly shows the diffusing area 37 as a defined portion on the surface of the diffuser 30 supported by a backing portion 34 and having a series of textures which, in the embodiment shown comprise a field of raised pyramids. The textured nature of the diffusing area 37 further disperses the light from the on-camera flash, greatly increasing diffusion while minimally decreasing lighting efficiency. In a further embodiment, the corners of the diffuser 30 proximate to the diffusing area 37 may be rounded or otherwise blunted. In yet another embodiment, the longer edges of the diffuser 30 which are coplanar with the diffuser 30 may also be rounded or otherwise beveled.

While the purpose the of the diffuser 30 is to ameliorate the harsh effects of direct lighting from on-camera flashes, some amount of direct light, or “key light” is desirable to provide an amount of specularity in an exposed image. The higher intensity light gives a catchlight to the eyes of photographic subjects and prevents an image from appearing too soft. Accordingly, the lighting properties of the diffuser 30 can be varied by varying the relative proportions of the diffuser 30, specifically the proportion of the diffusing or textured area of the diffuser to the untextured area. A larger textured area causes the diffuser to provide proportionally less of a direct and more of a diffused lighting effect. Conversely, a relatively smaller textured area affects the balance of the lighting effect created by the diffuser in the opposite manner. The compound surfaces of the diffuser pictured in FIG. 3 having a diffusing area 37 on the diffusing end 32, as well as a smooth portion closer to the mounting end 31, are designed to strike a balance between an image that is too harsh and one that is too soft.

In the embodiment shown in FIG. 3, a generally triangular or wedge shaped filter is provided using a textured area comprising a grid of small pyramids to further disperse light. These pyramids greatly increase flash diffusion with minimal loss of efficiency. When the light hits the rear of the diffuser 30, the entire wedge shaped diffuser 30 is lit giving a large shape lighting source, and the pyramids send light throughout the subject area. This provides a favorable lighting ratio for shots taken with the diffuser 30, reducing shadows on the subject and giving a diffuse, soft light all around the room as well as on the subject. For large group shots, the lighting quality is soft, beautiful and diffuse. Reflections from the rear of the diffuser 30 allow an amount of light to bounce around the room and off of the ceiling onto the subject yielding a beautiful, natural lighting effect.

The diffuser 30 may in an exemplary embodiment be formed from plastics using a vacuum molding process. It may also be made from other molding and non-molding plastic forming processes, as well as being formed from other appropriate semi-transparent or translucent materials as will be understood by one skilled in the art. The mold surface may be roughened to provide the diffuser 30 with a semi-transparent or translucent finish. This roughened surface may be created by treating the mold with a sand or bead blasting process. It will be understood by one skilled in the art that because the small flashes used in point and shoot digital applications and the like are so concentrated, a correspondingly opaque plastic is needed for the diffuser 30.

On occasion, a user desires that the diffused light in a shot have a particular color quality. This can be provided with alternative embodiments of the present diffuser 30 wherein the material of the entire diffuser 30 itself, or specific portions of the diffuser such as the diffusing area 37, are formed having a particular hue. For example, the diffuser 30 can be made amber for inside shots to provide warmer skin tones and for overall warming in flash filled available light shots, and green for shots where there is a good deal of florescent lighting.

In yet another embodiment, the diffuser 30 is proportioned so that it is easy to pack and transport behind a camera when packed together in a standard camera/gadget bags, thus saving space. In this way, the diffuser may be packed together with the camera bag so that the diffuser does not take up substantially more room than the camera packed alone. In alternative embodiments, the diffuser 30 may be provided in a number of different shapes, and may be provided with a greater or lesser overall surface area. The diffuser need not be limited to a two-dimensional design, though it is envisioned that a flat diffuser will be the most convenient to transport as it can be easily tucked behind a camera in a travel bag assuming that the diffuser has about the same profile as the camera itself. In alternative embodiments, the diffuser 10 may be square, rectangular and having the same rough dimensions as a portable camera, circular having an aperture at its periphery, or some other shape known to one skilled in the art. In still another embodiment, the diffuser may include a cut-out which may be aligned with the viewfinder of the camera so as not to obscure the view through the viewfinder in the event the user prefers to line up the shot using the viewfinder instead of the electronic screen.

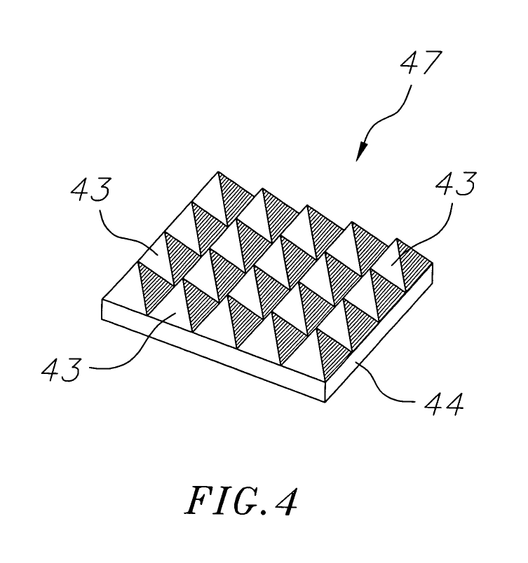

FIG. 4 shows a perspective view of a section of a diffusing surface a photographic light diffuser according another embodiment of the present invention. As discussed in the context of FIG. 3, a diffusing area 47 may comprise a backing portion 44 supporting a series of textures 43. In an exemplary embodiment, the textures comprise a field of raised pyramids. In a further embodiment, the pyramids have quadrilateral bases and tile in an orthogonal grid pattern. In yet another embodiment, the pyramids which make up the texture 43 are provided with bases approximately one quarter inch in length. Because of the provision of the textures 43 as part of the diffusing area 47 of the diffuser, a clearer plastic material may be used while still providing the same degree of diffusion overall, so that the lighting efficiency of the flash unit through the diffuser may be maximized.

What is claimed is:

1. A photographic light diffusing system comprising:
a camera having a lens unit and a flash unit;
a light diffuser comprising a semi-transparent panel having an aperture mounted on the lens unit of the camera, wherein the semi-transparent panel of the light diffuser obscures the flash unit when viewed from a subject in a field of view of the lens unit of the camera.

2. The photographic light diffusing system of claim 1, wherein the light diffuser is removably mounted on the lens unit of the camera.

3. The photographic light diffusing system of claim 1, wherein the camera includes a body, wherein the flash unit is mounted flush with the body of the camera, and wherein the lens unit is a telescopic unit capable of retracting flush with the body of the camera when not in use.

4. The photographic light diffusing system of claim 3, wherein the light diffuser is spaced from the body of the camera when mounted on the lens unit and in use.

5. The photographic light diffusing system of claim 3, wherein the light diffuser is spaced approximately one inch from the body of the camera when mounted on the lens unit and in use.

6. The photographic light diffusing system of claim 1, wherein the aperture of the light diffuser holds an adaptor ring allowing the light diffuser to be friction fitted to the lens unit of the camera.

7. The photographic light diffusing system of claim 6, wherein the adaptor ring includes protrusions extending from a circumference to a center of the adaptor ring.

8. The photographic light diffusing system of claim 1, wherein the semi-transparent panel of the light diffuser is tinted.

9. The photographic light diffusing system of claim 1, wherein the semi-transparent panel of the light diffuser includes a textured surface on a side of the semi-transparent panel furthest from the flash unit.

10. The photographic light diffusing system of claim 9, wherein the textured surface comprises a field of raised pyramids provided on the semi-transparent panel.

11. A photographic light diffuser comprising:
a first adaptor ring adapted to be mounted on a lens of a camera;
a second adaptor ring adapted to be mounted on the lens of the camera; and
a light diffuser comprising a semi-transparent panel having an aperture for receiving an adaptor ring,
wherein the first adaptor ring has an interior diameter equal to a first diameter, and an exterior diameter equal to a third diameter,
wherein the second adaptor ring has an interior diameter equal to a second diameter different than the first diameter, and an exterior diameter equal to the third diameter, and
wherein the aperture has a diameter equal to the third diameter.

12. The photographic light diffuser of claim 11, wherein at least one of the first adaptor ring and the second adaptor ring includes protrusions extending from a circumference to a center.

13. The photographic light diffuser of claim 11, wherein the semi-transparent panel of the light diffuser includes a textured surface on a side of the semi-transparent panel.

14. The photographic light diffuser of claim 11, wherein the semi-transparent panel of the light diffuser is formed from vacuum molded plastic.

15. A photographic light diffuser having a semi-transparent panel, wherein the semi-transparent panel has an aperture adapted to be mounted on a lens unit of a camera, and wherein the semi-transparent panel obscures a flash unit of the camera when viewed from a subject in a field of view of the lens unit of the camera.

16. The photographic light diffusing system of claim 15, wherein the light diffuser is adapted to be removably mounted on the lens unit of the camera.

17. The photographic light diffusing system of claim 15, wherein the light diffuser is adapted to be mounted on the lens unit of the camera in a position spaced from a body of the camera.

18. The photographic light diffusing system of claim 15, wherein the aperture of the light diffuser holds an adaptor ring allowing the light diffuser to be friction fitted to the lens unit of the camera.

19. The photographic light diffusing system of claim 18, wherein the adaptor ring includes protrusions extending from a circumference to a center of the adaptor ring.

20. The photographic light diffusing system of claim 15, wherein the semi-transparent panel of the light diffuser includes a textured surface on at least one side of the semi-transparent panel.
